(19) United States
(12) Patent Application Publication
(10) Pub. No.: US 2024/0074469 A1
(43) Pub. Date: Mar. 7, 2024

(54) AERATED FREEZE-DRIED BABY-SNACK

(71) Applicant: SOCIETE DES PRODUITS NESTLE S.A., Vevey (CH)

(72) Inventor: JOHN BURTT, Pierson, MI (US)

(21) Appl. No.: 18/262,634

(22) PCT Filed: Jan. 18, 2022
(86) PCT No.: PCT/EP2022/050946

§ 371 Date: Jul. 24, 2023

Related U.S. Application Data
(60) Provisional application No. 63/141,579, filed on Jan. 26, 2021.

(51) Int. Cl. A23L 3/44; A23L 15/00; A23L 19/00

(52) U.S. Cl. CPC A23L 3/44; A23L 15/00; A23L 19/09

(57) ABSTRACT

The present invention relates to a freeze-dried aerated baby food snack comprising egg white, starch, natural buffer and at least one fruit ingredient and/or at least one vegetable ingredient; wherein the snack is clean label.

### BACKGROUND

Aerated compositions are known in the art. Aeration can provide desirable characteristics such as light, fluffy textures. It is also known in the art that aerated products are subject to physical and chemical instability and therefore can destabilize overtime. One solution to such instability issues includes the addition of a hydrated emulsifiers which are of chemical in nature. Gelatin is known as whipping aid, however there is a need for alternatives to gelatin. Egg being a well-known alternative due to its use in food product especially baked products such as meringue, cookies.

The product being subjected to these many processes and then being freeze dried it was not directly obvious, the results was surprising given that egg provides advantage to maintain the shape without the need for baking.

Freeze-drying is a process well known in the food industry. It is critical in further drying aerated products that the resulting product retain sensory attributes that are important to consumers.

EP2154982 relates to a freeze-dried, aerated dairy or dairy-substitute composition comprising a dairy or dairy-substitute ingredient and an emulsifier and methods of making thereof.

EP2670256 provides aerated food products containing hydrophobins, and proteins which do not interfere with hydrophobins, and of which the texture remains stable during storage.

US20070026129 relates to an aerated food composition having a high protein content as well as pleasant organoleptic properties.

EP3197293 relates to a whippable food product has less than 5% by weight fat and includes about 0.5% to about 30% by weight of a dietary fiber; about 50% to about 95% by weight of water; up to about 5% by weight of a protein; up to about 5% by weight of a food starch; up to about 5% by weight of an emulsifier; and up to about 5% by weight of a hydrocolloid.

One challenge faced with developing snacks for children is dissolvability, this is an important issue in a freeze-dried product. Specifically, the aerated product, which has been dried and treated with air, must still remain readily dissolvable upon consumption at such a rate as to transfer flavor to the consumer's taste buds. Moreover, the product should be readily dissolvable to reduce the risk of choking hazards for consumers with restricted or under-developed oral motor skills or digestive functions. As a known solution, increasing the aeration can improve dissolvability. However, increased aeration has the negative effect of reducing the hardness of the end product. When the hardness is reduced, the physical stability of product can be compromised. Therefore, there is a need for a product that is freeze-dried and aerated that has improved physical stability and improved dissolvability.

### SUMMARY OF THE INVENTION

The present invention provides a “clean label” product devoid of any added sugar, gluten, preservatives, thickeners, artificial colors/flavors, emulsifiers, gums, whipping aids, additives, non-GMO (genetic modified food) and/or chemically synthesized materials.

In one aspect, the present invention relates to a freeze-dried aerated baby food snack comprising egg white, starch, natural buffer and at least one fruit ingredient and/or at least one vegetable ingredient; wherein the snack is clean label.

In another aspect, the present invention relates to a process for preparing a freeze-dried food snack comprising the steps of:
(i) Mixing egg white, tapioca starch and at least one fruit ingredient and/or at least one vegetable ingredient in presence of a natural buffer;
(ii) Subjecting the mix to a UHT process by heating till to 95° C.-100° C. for up to 3.0 minutes and cooling below 20° C.
(iii) Aerating the mix with nitrogen.
(iv) Depositing the aerated product to a shape (shape that assists in self feeding for a child) for e.g. dollop or drop
(v) Freeze drying the obtained shaped product:

The snack of the present invention is all-natural alternative to the complicated ingredient labels you find in snacks. These melts are dairy-free, gluten-free and Non-GMO.

The advantage is the snack of the present invention is tasty, light and airy freeze-dried snack that's made with only with real fruits, veggies and whipped egg whites to create a meltable snack that's great for any snack-time occasion. They're easy for your little one to pick up and feed themselves. The snack melts in babies mouth with good mouthfeel.

The results were also surprising that egg whites utilized in the types of products mentioned above maintained the aerated bubble structure through the batching, refrigeration, mixing, freezing, and freeze-drying process and did not need to be baked at high temperatures.

### DETAILED DESCRIPTION

As used throughout, ranges are used as a shorthand for describing each and every value that is within the range. Any value within the range can be selected as the terminus of the range. When used, the phrase “at least one of” refers to the selection of any one member individually or any combination of the members. The conjunction “and” or “or” can be used in the list of members, but the “at least one of” phrase is the controlling language. For example, at least one of A, B, and C is shorthand for A alone, B alone, C alone, A and B, B and

C, A and C, or A and B and C.

The healthy snack of the present invention is devoid of emulsifiers such as Mono- and di-glycerides of fatty acids INS471, Sodium stearoyl lactylate (SSL) E481, Diacetyltartaric and fatty acid esters of glycerol INS472e. The buffer- and stabilizing salts means Monosodium phosphate E339(i), Monopotassium phosphate E340 (i), Disodium phosphate E339 (ii), Dipotassium phosphate E340(ii), Di Potassium Phosphate INS340, Trisodium phosphate E339 (iii), Tripotassium phosphate E340 (iii), Sodium carbonate E500(i), Trisodium Citrate E331(iii), Sodium Hexameta Phosphate E452(i), Sodium Tri Poly Phosphate E451, Tetra Sodium Pyrophosphate INS450 (iii), Sodium Hexametaphosphate INS452i, Trisodium Citrate INS331iii, sodium or potassium ortho phosphates such as monophosphates, diphosphates or triphosphates, sodium or potassium polyphosphates, sodium or potassium mono- or bicarbonates, sodium or potassium citrates, hexametaphosphate or a combination thereof.

The healthy snack of the present invention is devoid of preservatives such as sodium benzoate, potassium benzoate.

The healthy snack of the present invention is devoid of thickeners such as pectins.

“Freeze-dry” is a dehydration process that works by freezing the material and then reducing the surrounding pressure to allow the frozen water in the material to sublimate directly from the solid phase to gas.

“Aeration” is the process of introducing air to increase gas concentration in liquids. Aeration may be performed by bubbling a gas through the liquid, spraying the liquid into the gas or agitation of the liquid to increase surface absorption.

“Dissolvability” is defined as the change in hardness of a product in going from a dry to a wet state. The egg white is providing protein to provide structure and starch providing the initial thickness or viscosity of the mixture.

“Hardness” is defined as the peak stress prior to fracturing a material. Universal Tester model 4465 with 100 N static load cell, manufactured by Instron in Canton, MA, is used. The probe used for testing is a compression anvil #2830-011. Initial settings for speed of probe were 1 mm/second to approximately 90% compression. Speed based upon journal article in J. Texture Studies, 36 (2005), pp 157-173, “Effects of Sample Thickness of Bite Force for Raw Carrots and Fish Gels.” Testing is repeated on 10-15 replicate samples for each variable.

“Viscosity” is defined as a measure of the resistance of a substance to flow. Viscosity is measured using a Brookfield viscometer with a Helipath® stand with an F-T bar before the composition is aerated. Viscosity aids in holding the shape of a substance through aeration and deposit. The thickness of the product controlled and measured by viscosity along with the use of egg whites for aeration of the substance is one embodiment of the present invention, the viscosity ranges from 50,000 to 250,000 cps.

“Solubility” is defined as ability of substance to dissolve in a solvent in form of a solution without any sediments.

The consumer preference for the final product of the present invention is believed to be based on physical characteristics such as hardness, viscosity and dissolvability. While each characteristic is important, the correct balance between the three components is desired to optimize the end product of the present invention. Viscosity is defined as a measure of the resistance of a substance to flow. Viscosity is measured using a Brookfield viscometer with a Helipath® stand with an F-T bar before the composition is aerated. It is believed that while the viscosity aids in holding the shape of a substance through aeration and deposit, the hardness aids in physical stability. The dissolvability, also a hardness measurement, is the change in hardness of a product in going from a dry to a wet state. With increased aeration, which aids in dissolvability, the hardness can be negatively affected. The compositions and methods of the present invention have unexpectedly discovered the optimum balance between viscosity, hardness and dissolvability to provide a physically stable and consumer acceptable product.

In one embodiment of the present invention, the starch comprises tapioca starch, potato starch and/or corn starch added to result in a viscosity ranging from 50,000 to 250,000 centipoise.

In one embodiment of the present invention, the natural buffer is lemon juice.

In one embodiment of the present invention, the egg white comprises in amount ranging from 0.5 to 1.5% w/w.

The present invention comprises a fruit or vegetable composition useful in the preparation of a freeze-dried, aerated product. The first component of the composition comprises a fruit or vegetable ingredient.

The fruit or vegetable ingredient is selected from any ordinarily known in the art. Preferably, the fruit or vegetable ingredient is pureed. The fruit or vegetable ingredient is present in amount of from 60% to 98%, preferably from 70% to 90% and most preferably from 60% to 80% of the composition. In one embodiment of the present invention, the fruit ingredient comprises in amount ranging from 80-98% w/w. In another embodiment of the present invention, the vegetable ingredient comprises in amount ranging up to 20% w/w.

In one embodiment of the present invention, the fruit ingredient does not contain added sugar and comprises banana, kiwi, grapefruit, blueberry, apple, mango, pear, guava, strawberry, peach, raspberry, and combinations thereof. In another embodiment of the present invention, the vegetable ingredient comprises whole vegetables, vegetable puree, peas, carrots, sweet potato, Zucchini, squash (all varieties including butternut) and combinations thereof.

The composition of the present invention has a dissolvability in the range of from 0.002-0.030 g/minute, with preferred range 0.010-0.020 g/min. The composition of the present invention has a viscosity of from 50,000 to 250,000 cp, dependent upon the temperature and speed of the viscometer used to measure the viscosity. In the preferred embodiment, the viscosity of the wet composition ranges from 50,000 to 250,000 cp at a 5 RPM speed of the spindle T-bar F in a Brookfield Viscometer.

### EXAMPLES

Tables 1 and 2 below describes two different recipes of the present invention.

A majority (¹⁸ 80%) of the Fruit Purees are added to batch tank with agitation. The dry ingredients are slowly added with mixing. These include egg white powder, tapioca starch, and ascorbic acid. Following step involved adding the remaining fruit purees to the batch. Lemon Juice concentrate is then added to lower the pH of the batch to 4.00 to 4.10. The final tank is mixed for 2-5 minutes. The product is next pre-heated indirectly to 125-130′F. Product is then processed on UHT at approximately 95-100′C for up to 3 minutes. After UHT treatment, produced is indirectly cooled below 20′C. Product is then aseptically packaging into 2000 pound aseptic tote. Aseptic tote is stored in refrigerated temperature 1-5′C.

Testing:
At 24 hours a refrigerated sample, Brookfield Viscosity, helipath, T-bar F at 5 rpm for seconds.

Results:
Viscosity (24 hr): 50,000 cps-250,000 cps (both products, T-bar F, Helipath, 5 rpm, 30 seconds).
Batch pH: 3.95-4.10 Banana Pear
Batch pH: 3.95-4.10 Banana Apple Blueberry
Brix: 20.6-20.8 Banana Pear
Brix: 20.3-20.8 Banana Apple Blueberry
Total Solids: 21-25% Banana Pear (target 24.51%—individual ingredient calculation)
Total Solids: 21-25% Banana Apple Blueberry (target 24.65%—individual ingredient calculation).

TABLE 1
Banana Apple Blueberry Whips

| Ingredient Description | Percent (%) |
|---|---|
| Bananas | 60-80 |
| Blueberries | 0-10 |
| Apples | 10-40 |
| Tapioca Starch | 1.0-3.0 |
| Ascorbic Acid | 0.0-1.0 |
| Lemon Juice Concentrate | 0-2.0 |
| Egg White Powder | 0.50-1.50 |
| Total | 100.00 |

TABLE 2
Banana Pear Whips

| Ingredient Description | Percent (%) |
|---|---|
| Bananas | 60-80 |
| Pears | 20-40 |
| Lemon Juice Concentrate | 0-2.0 |
| Tapioca Starch | 1.0-3.0 |
| Ascorbic Acid | 0-1.0 |
| Egg White Powder | 0.50-1.50 |
| Total | 100.00 |

### Solubility:

The below table 3 provides time (in minutes) for the two different products of the present invention and 2 controls not of this invention to dissolve in water. The products of this invention dissolve faster.

### Dissolvability Data:

Dissolvability data shown below (Table 4). Sample 1 and 2 are two formulations according to the present invention.

TABLE 4

| | Number of | Mean |
|---|---|---|
| Product description | tests | (g/min) |
| Control (FV Tropical) | 30 | 0.004 |
| Sample 1 (Banana Apple Blueberry) | 30 | 0.013 |
| Sample 2 (Banana Pear) | 30 | 0.017 |

1. A freeze-dried aerated baby food snack comprising egg white, starch, natural buffer, at least one ingredient selected from the group consisting of a fruit ingredient and a vegetable ingredient and wherein the snack is clean label.

2. The snack of claim 1, wherein the starch is selected from the group consisting of tapioca starch, potato starch and corn starch and the snack has a viscosity ranging from 50,000 to 250,000 centipoise.

3. The snack of claim 1, wherein the natural buffer is lemon juice.

4. The snack of claim 1, wherein the egg white comprises from 0.5 to 1.5% w/w.

5. The snack of claim 1, wherein the fruit ingredient comprises from 80-98% w/w.

6. The snack of claim 1, wherein the vegetable ingredient comprises up to 20% w/w.

7. The snack of claim 1, wherein the fruit ingredient does not contain added sugar and comprises banana, kiwi, grapefruit, blueberry, apple, mango, pear, guava, strawberry, peach, raspberry, and combinations thereof.

8. The snack of claim 1, wherein the vegetable ingredient comprises whole vegetables, vegetable puree, peas, carrots, sweet potato, Zucchini, squash (all varieties including butternut) and combinations thereof.

9. The snack of claim 1 configured to dissolve in range of 0.002 to 0.030 g/minute.

10. A process for preparing a freeze-dried food snack comprising the steps of:
(i) Mixing egg white, tapioca starch and at least one fruit ingredient and/or at least one vegetable ingredient in presence of a natural buffer;
(ii) Subjecting the mix to a UHT process by heating till to 95° C.-100° C. for up to 3.0 minutes and cooling below 20° C.;
(iii) Aerating the mix with nitrogen;
(iv) Depositing the aerated product to a shape (shape that assists in self feeding for a child) for e.g. dollop or drop; and
(v) Freeze drying the obtained shaped product.

11. The process of claim 10 wherein after step (iii) storing the UHT treated mix at temperature of 1-5° C. for up to 180 days; followed by a mixing and aeration step (iii).
